(19) United States
(12) Patent Application Publication
(10) Pub. No.: US 2005/0035217 A1
(43) Pub. Date: Feb. 17, 2005

(54) Atomization head for a ULV spray machine

(76) Inventors: Charles Wilhite, Danbury, TX (US); James Smoot, Angleton, TX (US)

Correspondence Address: Charles Wilhite, 1414 Ave C, Danbury, TX, 77534, US

(21) Appl. No.: 10/915,660

(22) Filed: Aug. 10, 2004

Related U.S. Application Data
(60) Provisional application No. 60/495,267, filed on Aug. 15, 2003.

(51) Int. Cl. B05B 5/025

(52) U.S. Cl. 239/398

(57) ABSTRACT

The invention is a corrosion resistant spray head that has a stainless steel body (2) which encloses the interior components of the spray head assembly. The complete spray head assembly is easy to disassemble, is composed of parts that are all corrosion resistant. The spray head has an internal insecticide delivery line (8) that eliminates kinking or flattening of the delivery line due to the corrosion resistant tubing insert (30) in the line.

### CROSS-REFERENCE TO RELATED APPLICATIONS

PPA #60/495267 Dated Aug. 15, 2003

### FEDERALLY SPONSORED RESEARCH

Not Applicable

### SEQUENCE LISTING OR PROGRAM

Not Applicable

### BACKGROUND OF THE INVENTION —FIELD OF INVENTION

This invention relates to the proper dispersal of insecticide droplets through a spray head which is attached to a blower or compressor and drive motor. This machine would be used to spray insects.

### BACKGROUND OF THE INVENTION —PRIOR ART

The use of air flow to separate droplets into a particular size or to propel those droplets through a burner or spray device is included in a number of patents. U.S. Pat. No. 1,451,063 by Alfred Anthony demonstrated airflow use in a fuel burner to atomize the fuel for a better burn of that fuel. He utilized round holes for the airflow as opposed to the square or rectangular holes that we find in prior or current art in the insecticide atomization spray heads that is the subject of our invention. U.S. Pat. No. 2,047,570 by W. F. Wiltshire shows another way of using air flow to safely and efficiently control a fuel burner.

Several patents are currently in effect in regards to ultra low volume (ULV) spray machines. U.S. Pat. No. 3,552,652 by L. D. Greenwood is an atomizing nozzle for agricultural chemicals. This type nozzle is complicated, involves considerable expensive machining because of the curved and funneled parts and also utilizes air ducts that are rectangular. U.S. Pat. No. 3,666,177 by Samuel A. Mencacci is designed to apply chemicals in orchard applications. The spray head body has round holes that are cut in a curved pattern in order to stimulate circular airflow. The idea of using round air flow holes is present in a different type sprayer but once again, costly machining is necessary to produce those curved flow routes. The earlier versions of ULV spray machines, such as U.S. Pat. No. 3,917,168 by W. L. Tenney used hot compressed air to dispense the fluid material. Flow of the product could be controlled from the cab of the vehicle. This particular style of flow control is dangerous, however, because the insecticide product flows through the flow control meter located in the cab of the vehicle. A leak in the lines or the flow meter could have hazardous consequences. U.S. Pat. No. 3,702,306 by D. W. Waldron represents the atypical ULV spray machine utilized in mosquito control. These machines provide a method of turning a blower or compressor via a gasoline or electric motor to produce a stream of air to shear the insecticide into the proper size droplets for dispersion. Chemical product labels provide the required droplet sizes that one must achieve with the spray head utilized on any ULV spray machine.

These machines may be manual or electric start, they have fluid canisters for fuel and chemical and a pump to deliver the chemical to the spray head. The air flow produced by the blower or compressor provides the means to shear the chemical into the proper droplet size. The machines may have cutoff valves on the fluid delivery lines, a remote control box to operate the machine from the cab of a truck, tachometer and/or hour meters and even vibration dampeners for the engines. One feature of Waldron's U.S. Pat. No. 4,992,206 is a passage provided between the fluid introduction system and the duct system that allegedly provides for a quick cutoff of the spray fog. Our spray head eliminates such a passage and still provides quick cutoff because the volume of air flow at the face of the insecticide nozzle is greater then the propelling air flow through the nozzle.

The primary difference in most of these machines is the spray head, itself. Our spray head could be attached to any combination of motor, blower or compressor for air production, and pump to deliver the proper size droplet of spray as per label specifications.

The spray heads of prior art have been manufactured of mild steel that is painted or aluminum; however, no one has utilized a stainless steel body for enclosing the other stainless, brass, and plastic parts composing the spray head. One might believe that it would be obvious to do so since most of the insecticides used are corrosive. What has limited one from utilizing the stainless spray head body is the exorbitant cost to produce this part in the small quantities required for this specialized field of sprayers. We have solved this problem by using a product from the piping industry. This item is a stainless steel stub end which is a part of a slip flange. A slip flange makes it possible to mate up an existing pipe flange to a repair flange without having to perfectly align the bolt holes on the flange. We use this stainless stub end as the spray head body thereby eliminating the exorbitant cost of having some company mill or stamp out a spray head body. Our spray head has an unobvious use of a stub end or one would see it used in the prior art. The use of this stub end solves the cost factor of using a stainless steel spray head body. The other parts, the sum of which comprise all of the spray head except the previously mentioned spray head body, are made of chemical resistant brass, stainless steel, nylon, or tygon.

In prior art spray heads, air flow, used to shear the liquid stream into the proper size droplets, is channeled through a series of slots of square or rectangular proportions. These slots are not conducive to uniformity of airflow that is necessary for proper insecticide shear. The slots will work as evidenced by prior art spray machines passing label droplet specifications. However, our product utilizes round air outlet holes which offer less friction on the air stream. The airflow is less turbulent thus the insecticide is sheared into more consistently uniform droplets. This efficiency is demonstrated throughout industry as evidenced by piping and conduit being round as opposed to square or rectangular except in certain special sizing requirements. Air and liquids are moved primarily through round pipes.

Our spray head is comprised of more parts that are resistant to corrosion than any other prior art. As stated earlier, this is because we are using a stainless spray head body that is a non-obvious use of a piping industry product, a four inch stainless stub end (a six or eight inch stub end could also be used) which is a component of a slip flange (described earlier). This solves the cost factor of producing a spray head body without special machining or stamping on limited production spray machines.

The utilization of round holes to route compressor/blower air production to the nozzle face where the liquid is sheared to the proper droplet size provides more uniform air flow to all portions of the nozzle face than would the square or rectangular ports. These holes can be sized in relation to the air volume produced by the blower or compressor. Doing so allows one to then increase or decrease droplet size by increasing or decreasing the revolutions per minute of the blower or compressor.

Also, some prior art spray heads have shown a tendency to get kinks in the internal spray head insecticide delivery line. Kinking or flattening of this insecticide delivery line can reduce flow rates and impact droplet sizes and patterns. We have eliminated this problem by inserting a corrosion resistant metal tube inside the supply line itself.

Our spray head, which will be described further in the detailed description, meets another criteria for patentability in that our design has demonstrated commercial success since it was offered for sale after receiving a provisional patent No. 60/495,267 with a filing date of Aug. 15, 2003. Sales of these spray heads or complete machines have been purchased by private as well as government entities to combat West Nile Virus which is vectored by mosquitoes. This virus is just the latest in public health threats that involve mosquitoes and mankind's need to control outbreaks of particular species of mosquitoes in order to limit spread of a disease.

### BACKGROUND OF INVENTION—OBJECTS AND ADVANTAGES

Several objects and advantages of the invention are:
(a) to provide a spray head that is more resistant to corrosion;
(b) to provide a spray head that produces insecticide droplets in the proper size as per label specifications;
(c) to simplify the construction of and more economically produce a corrosion resistant spray head;
(d) to provide a spray head that is easy to disassemble and clean;
(e) to provide delivery of the insecticide material through a line that is designed to resist kinking or flattening that could reduce insecticide flow through the spray head.

### SUMMARY

In summary, our spray head provides a durable, less corrosive, and more efficient way to break up insecticide in order to provide optimum numbers of droplets that will kill mosquitoes.

### DRAWINGS—FIGURES

In reference to the drawings:

FIG. 1 is a cut away side view of the spray head on a reduced scale.

FIG. 2 is an exploded side view showing the component parts of the spray head on a reduced scale.

FIG. 3 is a frontal view of the spray head on a reduced scale

### DRAWINGS—REFERENCE NUMERALS

2 stainless steel spray head body
4 threaded coupler
6 nylon tie strap
8 chemical hose
10 center drilled plug
12 threaded 90 degree barbed hose fitting
14 stainless steel nozzle
16 nozzle body
18 six equidistantly drilled holes in nozzle body
20 droplet dispersion plate
22 stainless steel face plate
24 stainless steel bolt
26 stainless steel machine screw
28 stainless steel metal screw
30 tubing insert
32 drilled hole-size drill bit
34 fiber face plate gasket
36 stainless steel lock washer and nut

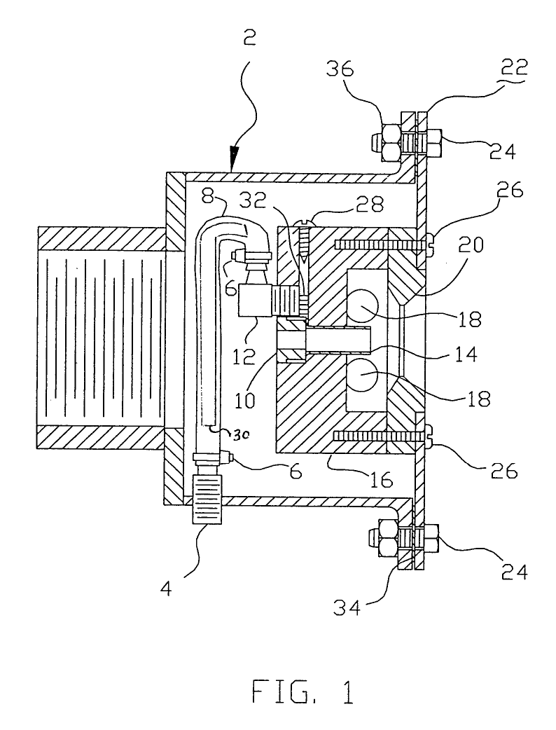

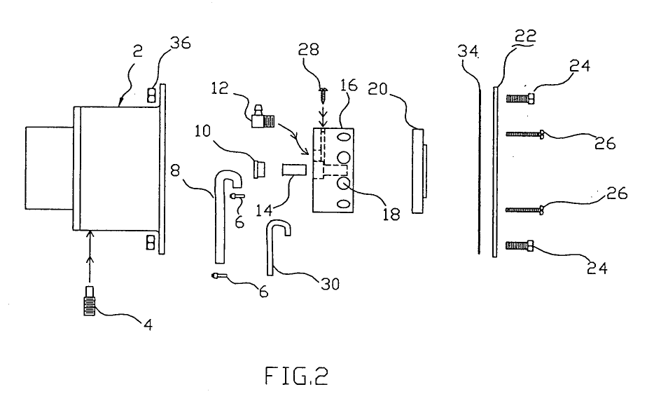

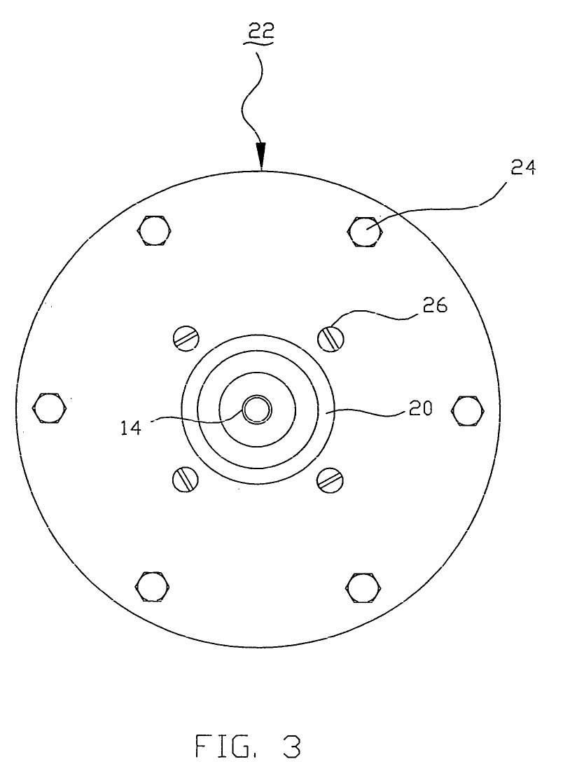

### DETAILED DESCRIPTION—FIGS. 1, 2 AND 3

Referring to FIG. 1, the stainless steel spray head body 2, should be attached to an air source (blower or compressor) by way of a pipe conduit. The spray head body 2 has a threaded connector which has been arc-welded to the body. A threaded coupler 4, which is connected to a insecticide tank by means of a chemical delivery line (not shown), is inserted through a threaded hole in the stainless body 2. Insecticide enters the sprayer body by way of a chemical resistant hose 8. This chemical hose 8 has a tubing insert 30 to prevent the line from kinking or collapsing. The insecticide continues through a threaded 90 degree barbed hose fitting 12. The hose 8 is held in place on the barbed fitting by two tie straps 6. A hole 32 is drilled through the nozzle body 16 to a chamber formed between the stainless nozzle 14 and the rear plug 10. This hole 32 is plugged at the exterior of the nozzle body 16 with a #10 stainless steel metal screw 28. The only purpose of this hole 32 is to allow insecticide to enter the air flow from the threaded 90 degree barbed hose fitting 12. The rear plug 10 has a centered through hole that allows air to move the insecticide towards the nozzle 14 tip. The stainless nozzle 14 is flared at the rear to prevent it being pushed by air pressure through the nozzle body 16. A small chamber is left between the plug 10 and the nozzle 14 which provides an opening for insecticide to enter the rear of the nozzle 14.

Insecticide leaves the chamber behind the nozzle 14 and is pushed by air pressure entering the small hole in the rear plug 10 and exiting through the nozzle 14. As the insecticide reaches the front lip of the nozzle 14, a large volume of air from the blower or compressor enters a chamber (surrounding the nozzle 14 by way of a series of equidistantly drilled holes 18 around the diameter of the nozzle body 16. These holes 18 are drilled at an angle to the center axis of the nozzle body 16. The air stream entering these holes flows from outside the nozzle body 16 through the holes 18 to shear the insecticide exiting the nozzle 14. The volume of air flow through these holes is greater than the volume of air flow through the hole in the rear plug 10. The greater air volume delivered at the nozzle tip also provides a quick shutoff when insecticide flow is interrupted. This shearing action reduces the insecticide droplets to the proper size and then expels them through the droplet dispersion plate 20 which has a surface taper, from each side, towards a center hole. The droplet dispersion plate 20 has 4 holes on a bolt circle of sufficient diameter and is attached to a face plate 22 by means of 4 stainless steel #10 machine screws 26. There is a fiber gasket 34 between the spray head body 2 and the face plate 22. The nozzle body 16 has four threaded holes to accept the machine screws 26. The face plate 22 is attached to the spray head body 2 by six stainless bolts 24 utilizing stainless lock washers and stainless nuts (lock washer and nut as one item #36).

1. A spray head designed for ultra low volume spraying for the dispersal on insecticides where the spray head is comprised of all corrosion resistant parts. Many such spray heads in the prior art are not as resistant to corrosion.

2. A spray head as defined in claim 1 that has a stainless steel body unlike any other spray head produced. As mentioned in the background part of this application, the use of a stainless stub end, used in the piping industry, eliminates the high cost of milling or stamping the body of the spray head. If the usage of the afore-mentioned item were obvious, a previously patented spray head should have incorporated this item. Prior art producers would have been quite interested in utilizing such an item but were stymied by the cost factors involved with stamping or milling stainless steel spray head bodies in small quantities needed by producers of ULV machines.

3. A spray head as defined in claim 1 that shears the insecticide into the proper droplet size as per a label's specifications and that those droplet sizes can be increased or decreased in size by altering the air pressure and air volume through changing the rotational speed of the blower/compressor.

4. A spray head as defined in claim 1 which is easier to disassemble to clean or repair than prior art spray heads. The entire spray head can be unscrewed from the blower/compressor air delivery pipe and submerged in the appropriate liquid cleaner for that particular insecticide. The entire spray head can be disassembled by removing six stainless bolts and four stainless machine screws. The spray head can also be cleaned, while still on the spray apparatus, by flushing the appropriate cleaner through the spray head after introducing the cleaner into the air flow that shears the insecticide.

5. We claim that the equidistant round holes in the nozzle body provide a better method of introducing airflow across the nozzle face to shear the droplets into the proper size as per label specifications. Those specifications may vary from insecticide label to insecticide label and yet this spray head can provide the proper droplet size.

6. As defined in claim 5, our nozzle body, which has round holes for the entrance of the air flow to shear the insecticide, provides a less turbulent and thus a more uniform expulsion of the spray droplets than nozzle bodies that utilize square or rectangular holes. We refer to our earlier mention of the use of round pipe or tubing as opposed to square or rectangular tubing which would generate more friction on airflow through the spray head and less uniform distribution of air flow.

7. We claim a kink resistant, internal insecticide delivery line that has a corrosion resistant metal insert which prevents the possibility of reduced insecticide flow through the spray head.
Even though we have displayed, in the accompanying drawings, a preferred embodiment of the spray head, it is understood that certain modifications could be made without departing from the general embodiment of the design. Different sizes of nuts and bolts could be used. Different sizes of spray head bodies and components could be utilized. Other modifications could be made as long as the spray head remained resistant to corrosion and maintained its ability to pass label recommended droplet sizes.
